(19) United States
(12) Patent Application Publication
(10) Pub. No.: US 2008/0135039 A1
(43) Pub. Date: Jun. 12, 2008

(54) COOKER

(75) Inventor: Terrell Larry Sharpe, Statesville, NC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: GRILLING SOLUTIONS, INC., Statesville, NC (US)

(21) Appl. No.: 11/567,901

(22) Filed: Dec. 7, 2006

(51) Int. Cl. A47J 37/07; F24B 3/00

(52) U.S. Cl. 126/25 R; 99/426

(57) ABSTRACT

A high-moisture food cooker is provided that has an upright tubular food-receiving housing having a top edge, a sidewall, and a bottom edge. A fuel support is positioned in the housing and is vertically spaced from the bottom edge for receiving and supporting a carbonaceous fuel such as charcoal during a cooking process. A plurality of spaced-apart side vents are formed and positioned in the sidewalls of the housing proximate the fuel support for allowing a free flow of air from outside the housing onto the fuel. A food support is positioned in use on the fuel support and is adapted to space and support the food above the fuel during the cooking process. The food support has a sufficient surface area to support the food while allowing free heat flow from the fuel onto the food.

### TECHNICAL FIELD AND BACKGROUND OF THE INVENTION

This invention relates to a cooker for cooking a high-moisture food item and more specifically for cooking a high-moisture food item with a predetermined amount of fuel.

Cookers such as grills, stoves, ovens, and other devices are used to cook high-moisture food items such as meat. Some known cookers are portable and can be used during occasions such as camping, tail-gating, and parties. Conventional cookers include a heat source and a support structure for positioning the food item to be cooked such that it is exposed to the heat source.

Conventional cooker support structures include grates, spits, and other implements such as pans or bowls positioned near the heat source. Conventional heat sources for portable cookers include electric resistance heaters and combustible fuels such as wood, gas, wax, and charcoal. During the cooking process the combustible fuel burns and generates heat. The support structure maintains the position of the food item such that it is exposed to the heat until the food item is adequately cooked.

A drawback with known portable cookers is that extensive monitoring and adjustments are required to achieve a satisfactory result. Such adjustments include the addition of fuel during the cooking process and repositioning of the food item to avoid overcooking or undercooking. As a result, a uniformly cooked food item is difficult to obtain. Known types of cooking equipment that provide more evenly cooked food items such as rotisseries are often bulky, difficult to transport, and expensive.

### SUMMARY OF THE INVENTION

Therefore, it is an object of the invention to provide a portable cooker for using a predetermined amount of fuel that can be added at one time.

It is another object of the invention to provide a portable cooker for cooking a food item over a combustible heat source without repositioning the food item during cooking.

These and other objects and advantages of the invention are disclosed below, where a high-moisture food cooker is provided that has an upright tubular food-receiving housing having a top edge, a sidewall, and a bottom edge. A fuel support is positioned in the housing and is vertically spaced from the bottom edge for receiving and supporting a carbonaceous fuel such as charcoal during a cooking process. A plurality of spaced-apart side vents are formed and positioned in the sidewalls of the housing proximate the fuel support for allowing a free flow of air from outside the housing onto the fuel. A food support is positioned in use on the fuel support and is adapted to space and support the food above the fuel during the cooking process. The food support has a sufficient surface area to support the food while allowing free heat flow from the fuel onto the food.

In accordance with one embodiment of the invention, the tubular housing is circular in cross-section.

In accordance with a further embodiment of the invention, the diameter of the housing is at least 50 percent of the height of the housing from the top edge to the bottom edge.

In accordance with a further embodiment of the invention, the housing includes a plurality of legs for spacing the fuel support above the bottom edge.

In accordance with a further embodiment of the invention, the fuel support is a non-foraminous metal sheet that substantially completely encloses the bottom of the housing.

In accordance with a further embodiment of the invention, the food support comprises a U-shaped table.

In accordance with a further embodiment of the invention, the food support comprises a U-shaped table extending across the housing from one side to an opposite side.

In accordance with a further embodiment of the invention, the housing is sized to receive a fowl along a head to tail axis.

In accordance with a further embodiment of the invention, the top edge of the housing and the bottom edge of the housing are spaced about 9 inches apart and the housing is generally circular with a diameter of about 6.5 inches.

In accordance with a further embodiment of the invention, the sidewalls of the housing and the fuel support are formed of approximately 18 gauge steel.

In accordance with a further embodiment of the invention, the fuel support is positioned about 2 inches from the bottom edge of the housing.

In accordance with a further embodiment of the invention, the food support is a U-shaped table that has a generally rectangular top and two legs that are positioned at opposites ends of, and extend from one side of, the generally rectangular top.

In accordance with a further embodiment of the invention, the generally rectangular top is about two inches wide and about six inches long.

In accordance with a further embodiment of the invention, each of the two legs are about two inches long and two inches wide.

In accordance with a method embodiment of the invention, the method includes the steps of providing an upright tubular food-receiving housing having a top edge, sidewalls, a bottom edge, and a fuel support positioned in the housing. The fuel support is vertically spaced from the bottom edge for receiving and supporting a fuel during a cooking process. A plurality of spaced-apart side vents are formed in the sidewalls of the housing proximate the fuel support for allowing a free flow of air from outside the housing onto the fuel. A food support is provided, and is positioned in use on the fuel support and adapted to space and support the food above the fuel during the cooking process. The food support has a sufficient surface area to support the food while allowing free heat flow from the fuel onto the food. The food item is enclosed in a heat and moisture-retentive wrapping. A fuel is placed on a fuel support and ignited. The food item is placed on the food support and cooked to a suitable degree of doneness.

In accordance with a further method embodiment of the invention, the step of wrapping further includes the step of providing a first and a second layer of wrapping that each have a long axis and are each dimensioned to be folded such that the food item is enclosed.

In accordance with a further embodiment of the invention, the axis of the first layer and the long axis of the second layer cross at an angle of about ninety degrees.

In accordance with a further embodiment of the invention, the wrapping is metal foil.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a perspective view showing a cooker and food item to be cooked according to one embodiment of the present invention;

FIG. 2 is an exploded view of the cooker and food item of FIG. 1;

FIG. 3 is a vertical cross-section of the cooker containing fuel and a food item to be cooked;

FIGS. 4 and 4A illustrate the manner in which a food item may be enclosed in a foil wrapper for cooking.

### DESCRIPTION OF THE PREFERRED EMBODIMENT AND BEST MODE

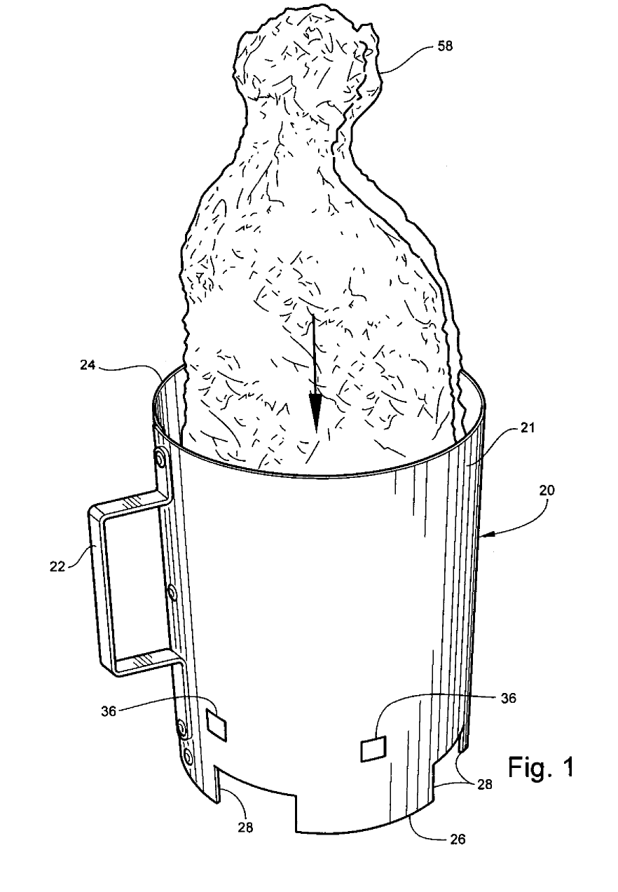

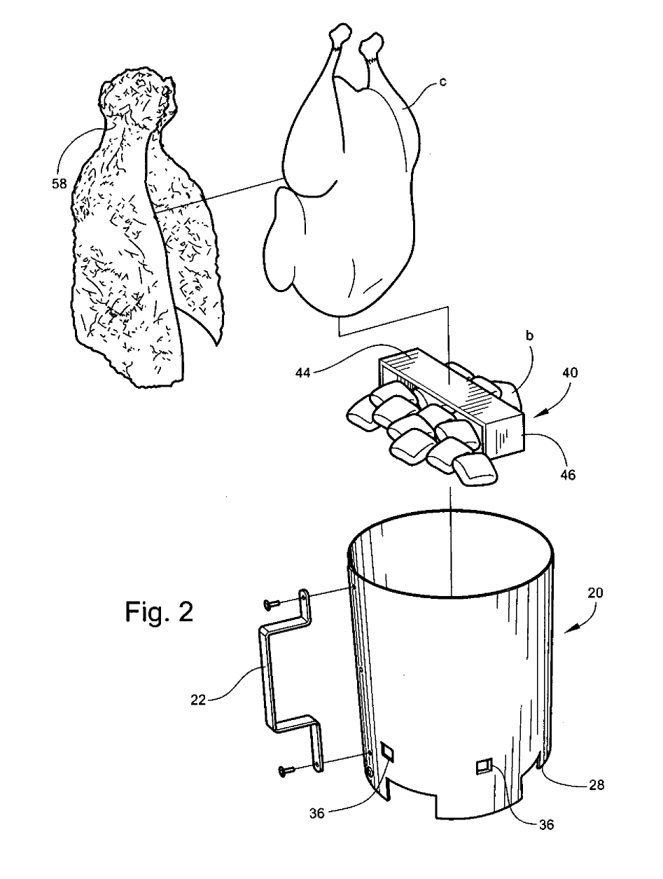

Referring now specifically to the drawings, a cooker according to an embodiment of the invention is illustrated in FIG. 1 and shown generally at reference numeral 10. As shown in FIG. 2, the cooker 10 includes a housing 20, a fuel support 32 and a food support, i.e. table 40 and is for cooking food items without replenishing an initial amount of a carbonaceous fuel such as a charcoal.

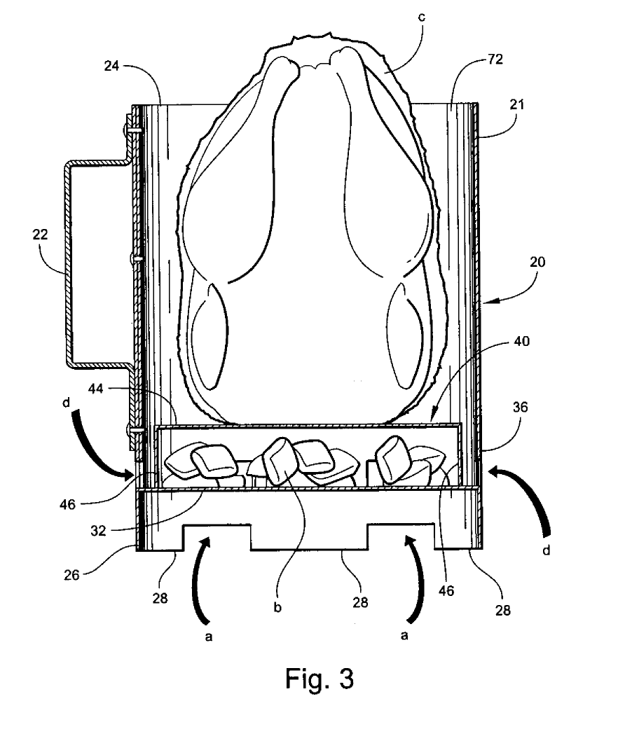

Referring now to FIGS. 2 and 3, the housing 20 is generally tubular and includes a side wall 21. The side wall 21 is generally cylindrical in shape. However, it should be appreciated that the housing 20 can be some shape other than cylindrical, such as square or star shaped. In one embodiment, the housing 20 has a top edge 24 and a bottom edge 26 that are spaced about 9 inches apart, and the housing 20 has a diameter of about 6.5 inches. Preferably, the diameter of the housing 20 is at least fifty percent of the height of the housing 20. Housing 20 is suitably sized to accommodate poultry, pork roast, seafood, and the like.

A handle 22 is attached to the exterior of the housing 20 and dimensioned for a cook to grasp and maneuver the cooker 10. Preferably, the handle 22 is sufficiently sized and spaced from the side wall 21 to accommodate a glove or other device for protecting the cook. Handle 22 can be dimensioned to accommodate a tool such as tongs and can be configured such that it is attached to the housing 20 at only one location or at several different locations.

Referring now to FIGS. 1 and 3, the housing 20 includes a plurality of legs 28 for supporting the housing 20 and for spacing the fuel support 32 above the bottom edge 26. In one embodiment, the legs 28 are dimensioned such that the fuel support 32 is spaced apart from the bottom edge 26 of the housing 20 sufficiently to allow air (a) to circulate under fuel support 32 to avoid damage caused by heat to a surface on which the housing 20 is supported. In the illustrated embodiment, the fuel support 32 is a plate, or sheet steel, that is welded into and substantially completely encloses one end of the housing 20. In a preferred embodiment, the fuel support 32 is non-foraminous. The fuel support 32 is dimensioned to support a carbonaceous fuel such as charcoal briquets (b) during the combustion of the fuel. By way of example and not limitation, fuels that can be supported on the fuel support 32 include: charcoal briquets, wood, wax, petroleum distillates, cloth, other combustible material, and a combination thereof.

As can be seen in FIGS. 1 and 3, a plurality of spaced-apart side vents 36 are formed and positioned in the sidewall 21 of the housing 20 proximate the fuel support 32. Preferably, each of the side vents 36 is rectangular but could be any other geometric shape. In the illustrated embodiment, the side vents 36 are square and are spaced radially around the housing 20. The side vents 36 are dimensioned to allow a free flow, or draft (d), of air over the fuel support 32 from outside the housing 20. The side vents 36 are sized such that sufficient oxygen enters the housing 20 to support combustion of the fuel for a predetermined duration. In one embodiment, the predetermined duration is about 3 hours. The side vents 36 have a total area of, preferably, from about 0.5 sq. in. to about 3 sq. in, more preferably, from about 1 sq. in. to about 2 sq. in., and even more preferably, from about 1.25 sq. in. to about 1.75 sq. in. The illustrated embodiment includes six side vents 36 that each have an area of about 0.25 square inches for a total area of about 1.5 square inches.

The fuel support 32 is also dimensioned to indirectly support the food item by supporting the table 40. As can be seen in FIG. 3, the table 40 is essentially a steel strip that is bent to form a U-shape having a top 44 and two legs 46. The table 40 is removable for placing fuel on the fuel support and is positioned within the housing 20 with the legs 46 supported on the fuel support 32 and the top 44 positioned above the fuel support 32 by about 2 inches. In one embodiment, top 44 is about 0.125 inches thick, about 2 inches wide, and about 6 inches, and each leg 46 is about 2 inches long.

The housing 20 is sized to receive a food item that is supported by the table 40. Generally the food item is one that contains a relatively high percentage of moisture, such as raw meat. The food item may be a chicken (c) having a head end and a tail end and is positioned along a head to tail axis in the cooker. The food item can also be some other meat, such as pork, beef or seafood, vegetables, grains, fruits, or a combination thereof.

The housing 20, the fuel support 32, and the table 42 can be formed of the same material or of different materials. In one embodiment, all components of the cooker 10 are formed of carbon steel and more specifically, the housing 20 and the fuel support 32 are formed of 18 gauge sheet steel. By way of example, the housing 20 and the fuel support 32 can be formed of other materials including stainless steel, other metallic materials, terra cotta, and other materials known to be suitable in the art. The surfaces of the cooker 10 can be painted or treated with some other functional or decorative finish. By way of example and not limitation, such finish treatments include shot blasting, anodization, coating with PTFE, or a combination thereof.

Referring now to the specific operation of the cooker 10, in a preferred embodiment, the housing 20 is positioned upright on a generally nonflammable supporting surface. Then a carbonaceous fuel such as charcoal briquets (b) is positioned on the fuel support 32, as shown in FIG. 3. Preferably, the briquets (b) are quick lighting such as Kingsford® Matchlight® Instant Light Charcoal available from the Kingsford Products Company. The briquets (b) are positioned across the fuel support 32 and the table 40 is placed onto the fuel support 32. Then, the briquets (b) are ignited by extending a source of ignition such as a match or lighter through one of the side vents 36 or through the top of the housing 20. After the briquets (b) have reached a satisfactory temperature, the food item is placed onto table 40. Preferably, about 8 to about 18 briquets (b) are positioned on the fuel support 32, more preferably, the number of briquets (b) is about 10 to about 16, even more preferably, the number of briquets (b) is about 12 to about 14.

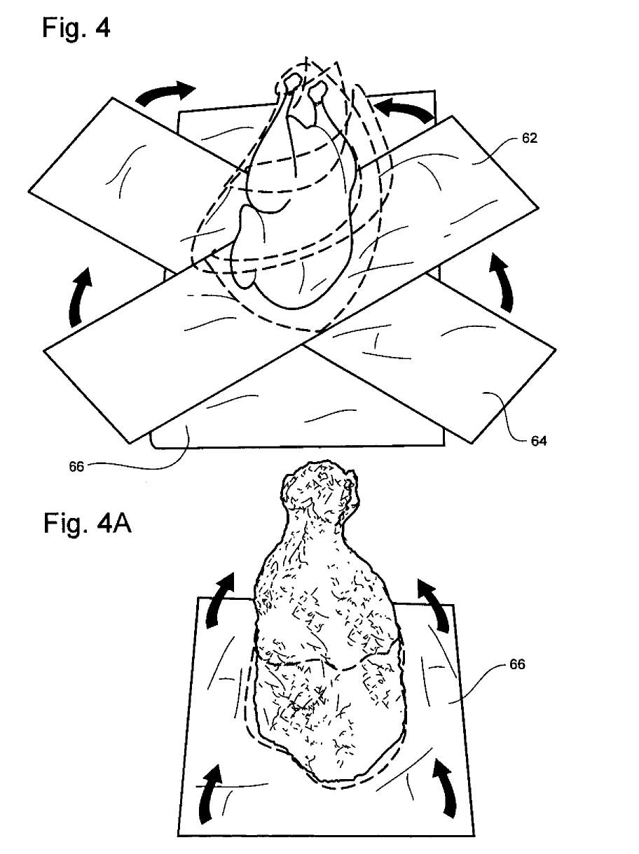

Referring now to FIG. 2, in one embodiment, the chicken (c) is contained within a package 58 that is a heat and moisture protective wrapping. Preferrably, the wrapping is a metal foil. In one embodiment, the wrapping material includes a polymeric material, e.g., a cooking bag, that is surrounded by metal foil. According to a preferred method of enclosing the chicken (c) within package 58, illustrated in FIGS. 4 and 4A, the chicken (c) is positioned such that the head end is down and in contact with a first foil sheet 62. The first sheet 62 is generally rectangular and has two opposite ends and two opposite long sides. The chicken (c) is positioned such that the first sheet 62 can be folded up around opposite sides of the chicken (c) such that the two opposite ends meet above the chicken (c). The ends are then crimped or folded together.

A second foil sheet 64 is then folded around the chicken (c) and the first sheet 62 at right angles to first sheet 62. After the second sheet 64 is wrapped around the chicken (c), a third foil sheet 66 is placed adjacent the neck end of the chicken (c) and crimped to form a “bowl” further protecting the bottom end of the chicken while retaining juices that accumulate during cooking.

Referring now to FIG. 3, the wrapped chicken (c) is placed within the housing 20. A space 72 is defined between the chicken (c) and that provides for the of hot air upwards around the chicken (c) and out of the housing 20. This effect draws air through the vents 36 and over the fuel on the fuel support 32. In a preferred embodiment, the space 72 has an effective cross sectional area of about 10 square inches.

A supplemental liquid such as water, broth, or oil may be placed within the package 58 along with the food item to be cooked to provide additional moisture and steam for adequate cooking of the food item.

A cooker for cooking a food item having a high moisture content and a method for using the same is described above. Various details of present invention may be changed without departing from its scope. Furthermore, the foregoing description of the preferred embodiment of the invention and the best mode for practicing the invention are provided for the purpose of illustration only and not for the purpose of limitation—the invention being defined by the claims.

1. A high-moisture food cooker; comprising:
(a) an upright tubular food-receiving housing having a top edge, a sidewall, and a bottom edge;
(b) a fuel support positioned in the housing and vertically spaced from the bottom edge for receiving and supporting a carbonaceous fuel such as charcoal during a cooking process;
(c) a plurality of spaced-apart side vents formed and positioned in the sidewalls of the housing proximate the fuel support for allowing a free flow of air from outside the housing onto the fuel;
and
(d) a food support for being positioned in use on the fuel support and adapted to space and support the food above the fuel during the cooking process, the food support having a sufficient surface area to support the food while allowing free heat flow from the fuel onto the food.

2. A cooker according to claim 1, wherein the tubular housing is circular in cross-section.

3. A cooker according to claim 1, wherein the diameter of the housing is at least 50 percent of the height of the housing from the top edge to the bottom edge.

4. A cooker according to claim 1, wherein the housing includes a plurality of legs for spacing the fuel support above the bottom edge.

5. A cooker according to claim 1, wherein the fuel support is a non-foraminous metal sheet that substantially completely encloses the bottom of the housing.

6. A cooker according to claim 1, wherein the food support comprises a U-shaped table.

7. A cooker according to claim 1, wherein the food support comprises a U-shaped table extending across the housing from one side to an opposite side.

8. A cooker according to claim 1, wherein the housing is sized to receive a fowl along a head to tail axis.

9. A cooker according to claim 1, wherein
(a) the top edge of the housing and bottom edge of the housing are spaced about 9 inches apart and the housing is generally circular with a diameter of about 6.5 inches;
(b) the sidewalls of the housing and the fuel support are formed of approximately 18 gauge steel; and
(c) the fuel support is positioned about 2 inches from the bottom edge of the housing.

10. A cooker according to claim 1, wherein
(a) the food support is a U-shaped table that has a generally rectangular top and two legs that are positioned at opposites ends of, and extend from one side of, the generally rectangular top;
(b) the generally rectangular top is about two inches wide and about six inches long; and
(c) each of the two legs is about two inches long and two inches wide.

11. A method of cooking a food item, comprising the steps of:
(a) providing:
(i) an upright tubular food-receiving housing having a top edge, sidewalls, and a bottom edge;
(ii) a fuel support positioned in the housing and vertically spaced from the bottom edge for receiving and supporting a fuel during a cooking process;
(iii) a plurality of spaced-apart side vents formed in the sidewalls of the housing proximate the fuel support for allowing a free flow of air from outside the housing onto the fuel; and
(iv) a food support for being positioned in use on the fuel support and adapted to space and support the food above the fuel during the cooking process, the food support having a sufficient surface area to support the food while allowing free heat flow from the fuel onto the food;
(b) enclosing a food item in a heat and moisture-retentive wrapping;
(c) placing a fuel on the fuel support;
(d) igniting the fuel;
(e) placing the food item in the housing on the food support; and
(f) cooking the food to a suitable degree of doneness.

12. A method of cooking a food item as defined in claim 12, wherein the step of wrapping further includes the steps of:
(i) providing a first and a second portion of wrapping that each have a long axis and are each dimensioned to be folded such that the food item is enclosed; and
(ii) wherein the long axis of the first portion of wrapping defines a first path along the food item and the long axis of the second portion of wrapping defines a second path along the food item.

13. A method of cooking a food item as defined in claim 12, wherein the first path and the second path cross at an angle of about ninety degrees.

14. A method of cooking a food item as defined in claim 11, wherein in the wrapping is metal foil.
